(19) United States
(12) Patent Application Publication
(10) Pub. No.: US 2020/0301336 A1
(43) Pub. Date: Sep. 24, 2020

(54) IMAGE FORMING APPARATUS AND IMAGE INSPECTION METHOD

(71) Applicant: Konica Minolta, Inc., Tokyo (JP)

(72) Inventors: Takashi Tsuchiya, Tokyo (JP); Daisuke Genda, Kawasaki-shi (JP)

(73) Assignee: Konica Minolta, Inc., Tokyo (JP)

(21) Appl. No.: 16/810,178

(22) Filed: Mar. 5, 2020

(30) Foreign Application Priority Data
Mar. 18, 2019 (JP) 2019-049604

(51) Int. Cl. G03G 15/00

(52) U.S. Cl. CPC G03G 15/5058

(57) ABSTRACT

An image forming apparatus includes: an image former that divides a first image into a plurality of second images and forms the second images on an image carrier; a test image reader that reads the second images formed on the image carrier; and a hardware processor that: selects a number of the second images from among the second images read by the test image reader, the number of the second images being smaller than a number of division of the first image; combines the selected second images into a combined image; and detects an image defect in the combined image.

### CROSS-REFERENCE TO RELATED APPLICATION

The entire disclosure of Japanese Patent Application No. 2019-049604, filed on Mar. 18, 2019, is incorporated herein by reference.

### BACKGROUND

### Technical Field

The present invention relates to an image forming apparatus and an image inspection method.

### Description of the Related Art

Image forming apparatuses (copying machines, printers, facsimiles, and complex machines having these functions) that form a toner image on a sheet sometimes fail to form a correct image on a sheet due to the durability of their components, resulting in image defects such as streaks and density unevenness. For this reason, a known type of image forming apparatus prints a dedicated image (test chart) for image analysis on a sheet, inspects the occurrence of an image defect or the like by reading the test chart on the sheet, and identifies the part to be replaced based on the inspection result (see, for example, JP 2018-132682 A).

A conventionally known test chart for image defect analysis is rectangular or band-shaped solid images with different color materials (e.g. Y, M, C, and K toners) continuously formed in different regions on a sheet.

When the above-mentioned test chart is printed on a sheet for image inspection and multiple types of image defects occur in one place on the sheet, deterioration occurs in the performance (e.g. accuracy) of detecting image defects in the prior art such as JP 2018-132682 A.

For example, when two types of image defects: a streak and density unevenness, occur in a concentrative manner in the solid image of one color material on the test chart, streak detection performance becomes poor in the density-difference-based analysis of image defects in the prior art.

### SUMMARY

One or more embodiments of the present invention provide an image forming apparatus and an image inspection method capable of preventing deterioration in image defect detection performance when multiple types of image defects occur.

According to one or more embodiments of the present invention, an image forming apparatus comprises: an image former that forms, on an image carrier, a plurality of second images that are divisions of a first image; a test image reader that reads the plurality of second images formed on the image carrier; and a hardware processor that selects and combines, into a combined image, a smaller number of second images than the number of divisions of the first image from among the plurality of second images read, wherein the hardware processor detects an image defect in the combined image.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view schematically illustrating the overall configuration of an image forming apparatus according to one or more embodiments;

FIG. 2 is a block diagram illustrating the main part of a control system in the image forming apparatus according to one or more embodiments;

FIGS. 3A and 3B are diagrams for explaining conventional image inspection that uses a test chart for image inspection;

FIG. 4 is a diagram illustrating an example of a test chart for image inspection used in the image forming apparatus according to one or more embodiments;

FIG. 5 is a diagram for explaining an example in which image defects occur when the test chart illustrated in FIG. 4 is output, according to one or more embodiments;

FIG. 6 is a diagram illustrating the black images extracted from the test chart illustrated in FIG. 5, according to one or more embodiments;

FIG. 7 is a diagram illustrating how the extracted black images are aligned according to one or more embodiments;

FIG. 8 is a diagram for explaining the process of matching the edges of black images according to one or more embodiments;

FIG. 9 is a diagram for explaining another specific example of a test chart and image inspection according to one or more embodiments;

FIGS. 10A and 10B are diagrams for explaining exemplary analysis processes for the printed test chart illustrated in FIG. 9 having streaks and density unevenness, according to one or more embodiments; and

FIG. 11 is a flowchart illustrating a specific processing example of an image inspection method according to one or more embodiments.

### DETAILED DESCRIPTION OF EMBODIMENTS

Hereinafter, an image forming apparatus according to embodiments of the present invention will be described in detail with reference to the drawings. However, the scope of the invention is not limited to the disclosed embodiments.

The following embodiments describe a case where the present invention is applied to an image forming apparatus such as a copying machine, a printer, and a facsimile. Hereinafter, the image forming apparatus according to the embodiments will be described in detail with reference to the drawings.

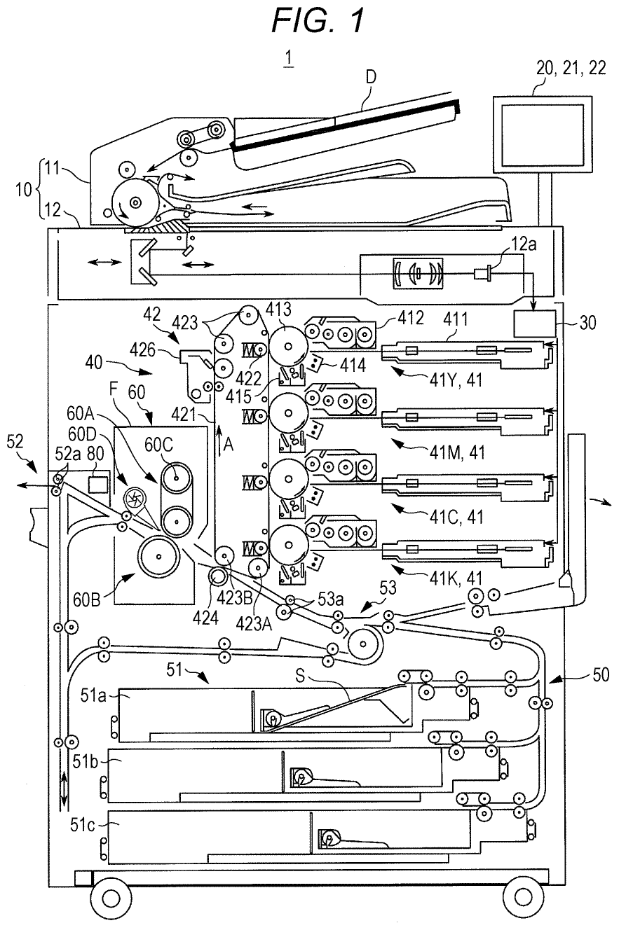

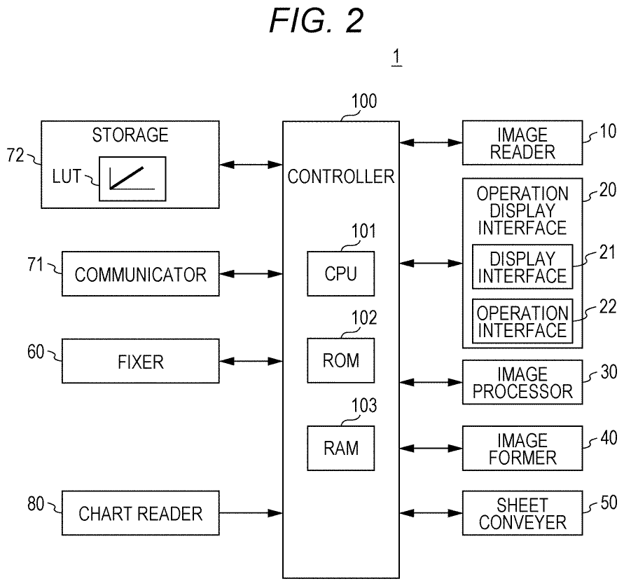

FIG. 1 is a view schematically illustrating the overall configuration of an image forming apparatus 1 according to one or more embodiments of the present invention. FIG. 2 is a diagram illustrating the main part of a control system in the image forming apparatus 1 according to one or more embodiments. The image forming apparatus 1 illustrated in FIGS. 1 and 2 is a color image forming apparatus utilizing an electrophotographic process technique.

That is, the image forming apparatus 1 primarily transfers toner images of respective colors of yellow (Y), magenta (M), cyan (C), and black (K) formed on photosensitive drums 413 onto an intermediate transfer belt 421, superimposes the toner images of the four colors on the intermediate transfer belt 421, and then secondarily transfers the toner images onto a sheet S, thereby forming a toner image.

The image forming apparatus 1 adopts a tandem system in which the photosensitive drums 413 corresponding to the four colors of Y, M, C, and K are disposed in series in the travel direction of the intermediate transfer belt 421, and the toner images of the respective colors are sequentially transferred onto the intermediate transfer belt 421 in a single procedure.

As illustrated in FIG. 2, the image forming apparatus 1 includes an image reader 10, an operation display interface 20, an image processor 30, an image forming device or image former 40, a sheet conveyer 50, a fixer 60, a chart reader 80, and a controller (or a hardware processor) 100.

The controller 100 includes a central processing unit (CPU) 101, a read only memory (ROM) 102, a random access memory (RAM) 103, and the like.

The CPU 101 reads a program corresponding to the processing content from the ROM 102, develops it in the RAM 103, and cooperates with the developed program to centrally control the operation of each block of the image forming apparatus 1. At this time, various data stored in a storage 72 are referred to. The storage 72 includes, for example, a nonvolatile semiconductor memory (what is called a flash memory) or a hard disk drive.

The controller 100 functions as an “image combiner” and a “detector” of one or more embodiments of the present invention.

The controller 100 transmits/receives, via a communicator 71, various data to/from an external device (for example, personal computer) connected to a communication network such as a local area network (LAN) and a wide area network (WAN). For example, the controller 100 receives image data transmitted from the external device so that a toner image is formed on the sheet S based on the image data (input image data). The communicator 71 includes, for example, a communication control card such as a LAN card.

The image reader 10 includes an automatic document feeding device 11 which is called an automatic document feeder (ADF), a document image scanning device 12 (scanner), and the like.

The automatic document feeding device 11 conveys a document D placed on a document tray by a conveying mechanism and sends it to the document image scanning device 12. The automatic document feeding device 11 can continuously read images (including both sides) of a large number of documents D placed on the document tray at once.

The document image scanning device 12 optically scans a document conveyed onto the contact glass from the automatic document feeding device 11 or a document placed on the contact glass, forms an image of reflected light from the document on a light receiving surface of a charge coupled device (CCD) sensor 12a, and reads the document image. The image reader 10 generates input image data based on a reading result provided by the document image scanning device 12. The input image data are subjected to a predetermined image process in the image processor 30.

The operation display interface 20 includes, for example, a liquid crystal display (LCD) with a touch panel, and functions as a display interface 21 and an operation interface 22. The display interface 21 displays various operation screens, the state of images, the operating condition of each function, and the like according to display control signals input from the controller 100. The operation interface 22 includes various operation keys such as a numeric keypad and a start key, accepts various input operations by a user, and outputs operation signals to the controller 100.

The image processor 30 includes a circuit or the like for performing a digital image process on the input image data according to initial setting or user setting. For example, under the control of the controller 100, the image processor 30 performs gradation correction based on gradation correction data (gradation correction table LUT) in the storage 72. Details of the gradation correction process will be described later.

In addition to the gradation correction, the image processor 30 subjects the input image data to various correction processes such as color correction and shading correction, a compression process, and the like. The image former 40 is controlled based on the image data subjected to these processes.

The image former 40 includes image forming units 41Y, 41M, 41C, and 41K for forming images with the respective color toners of the Y component, M component, C component, and K component based on the input image data, an intermediate transfer unit 42, and the like.

The image forming units 41Y, 41M, 41C, and 41K for the Y component, M component, C component, and K component have similar configurations. For the convenience of illustration and explanation, common components are denoted by the same reference signs, and Y, M, C, or K is added to the reference signs when the components are distinguished from one another. In FIG. 1, only the components of the image forming unit 41Y for the Y component are denoted by reference signs, and the reference signs of the components of the other image forming units 41M, 41C, and 41K are omitted.

The image forming unit 41 includes an exposure device 411, a developing device 412, the photosensitive drum 413, a charging device 414, a drum cleaning device 415, and the like.

The photosensitive drum 413 is a negatively charged organic photoconductor (OPC) including an undercoat layer (UCL), a charge generation layer (CGL), and a charge transport layer (CTL) sequentially laminated on a peripheral surface of a conductive cylinder made of aluminum (aluminum tube), for example. The charge generation layer includes an organic semiconductor in which a charge generation material (for example, phthalocyanine pigment) is dispersed in a resin binder (for example, polycarbonate), and generates a pair of positive and negative charges upon exposure by the exposure device 411. The charge transport layer is formed by dispersing a hole transporting material (electron-donating nitrogen-containing compound) in a resin binder (for example, polycarbonate resin), and transports the positive charge generated in the charge generation layer to the surface of the charge transport layer.

The controller 100 controls a driving current that is supplied to a driving motor (not illustrated) that rotates the photosensitive drum 413, thereby rotating the photosensitive drum 413 at a predetermined peripheral speed.

The charging device 414 uniformly charges the surface of the photosensitive drum 413 having photoconductivity to negative polarity. The exposure device 411 includes, for example, a semiconductor laser, and irradiates the photosensitive drum 413 with laser beams corresponding to the image of each color component. A positive charge is generated in the charge generation layer of the photosensitive drum 413 and transported to the surface of the charge transport layer, whereby the surface charge (negative charge) of the photosensitive drum 413 is neutralized. An electrostatic latent image of each color component is formed on the surface of the photosensitive drum 413 due to a potential difference between the surface and the surroundings.

The developing device 412 is a two-component developing device, for example, and visualizes the electrostatic latent image to form a toner image by attaching the toner of each color component to the surface of the photosensitive drum 413.

The drum cleaning device 415 has a drum cleaning blade or the like that is brought into sliding contact with the surface of the photosensitive drum 413 and removes the transfer residual toner remaining on the surface of the photosensitive drum 413 after primary transfer.

The intermediate transfer unit 42 includes the intermediate transfer belt 421 as an image carrier, a primary transfer roller 422, a plurality of support rollers 423, a secondary transfer roller 424, a belt cleaning device 426, and the like.

The intermediate transfer belt 421 is an endless belt, and is looped around the plurality of support rollers 423. At least one of the plurality of support rollers 423 includes a driving roller, and the others include driven rollers. For example, the roller 423A disposed on the downstream side of the primary transfer roller 422 for the K component in the belt travel direction may be a driving roller in one or more embodiments. This makes it easier to keep the travel speed of the belt at the primary transfer portion constant. As the driving roller 423A rotates, the intermediate transfer belt 421 travels at a constant speed in the direction of an arrow A.

The primary transfer roller 422 is disposed on the inner peripheral side of the intermediate transfer belt 421 so as to face the photosensitive drum 413 of each color component. A primary transfer nip for transferring a toner image from the photosensitive drum 413 onto the intermediate transfer belt 421 is formed by pressing the primary transfer roller 422 against the photosensitive drum 413 with the intermediate transfer belt 421 in between.

The secondary transfer roller 424 is disposed on the outer peripheral side of the intermediate transfer belt 421 so as to face a backup roller 423B disposed on the downstream side of the driving roller 423A in the belt travel direction. A secondary transfer nip for transferring a toner image from the intermediate transfer belt 421 onto the sheet S is formed by pressing the secondary transfer roller 424 against the backup roller 423B with the intermediate transfer belt 421 in between.

When the intermediate transfer belt 421 passes through the primary transfer nip, the toner images on the photosensitive drums 413 are sequentially superimposed and primarily transferred onto the intermediate transfer belt 421. Specifically, by applying a primary transfer bias to the primary transfer roller 422 and imparting a charge having the polarity opposite to that of the toner to the back side of the intermediate transfer belt 421 (side in contact with the primary transfer roller 422), the toner images are electrostatically transferred onto the intermediate transfer belt 421.

Thereafter, when the sheet S passes through the secondary transfer nip, the toner image on the intermediate transfer belt 421 is secondarily transferred onto the sheet S. Specifically, by applying a secondary transfer bias to the secondary transfer roller 424 and imparting a charge having the polarity opposite to that of the toner to the back side of the sheet S (side in contact with the secondary transfer roller 424), the toner image is electrostatically transferred onto the sheet S. The sheet S onto which the toner image has been transferred is conveyed toward the fixer 60.

The belt cleaning device 426 includes a belt cleaning blade or the like that is brought into sliding contact with the surface of the intermediate transfer belt 421 and removes the transfer residual toner remaining on the surface of the intermediate transfer belt 421 after secondary transfer. The secondary transfer roller 424 may be replaced with a configuration (what is called a belt-type secondary transfer unit) in which the secondary transfer belt is looped around a plurality of support rollers including a secondary transfer roller.

The fixer 60 includes an upper fixer 60A having a fixing surface side member disposed on the fixing surface side of the sheet S (surface on which a toner image is formed), a lower fixer 60B having a back side support member disposed on the back side of the sheet S (surface opposite to the fixing surface), a heating source 60C, and the like. By pressing the back side support member against the fixing surface side member, a fixing nip for holding and transporting the sheet S is formed.

In the fixer 60, the conveyed sheet S with the secondarily-transferred toner image is heated and pressurized at the fixing nip, whereby the toner image is fixed on the sheet S. The fixer 60 is disposed as a unit in a fixing device F. Further, an air separation unit 60D for separating the sheet S from the fixing surface side member by blowing air is disposed in the fixing device F.

The sheet conveyer 50 includes a sheet feeder 51, a sheet discharger 52, a conveyance path 53, and the like. In three sheet feed tray units 51a to 51c constituting the sheet feeder 51, sheets S (standard paper, special paper) identified based on basis weight, size, and the like are accommodated for each preset type. The conveyance path 53 has a plurality of conveying roller pairs such as a resist roller pair 53a.

The sheets S accommodated in the sheet feed tray units 51a to 51c are sent one by one from the uppermost portion and conveyed to the image former 40 by the conveyance path 53. At this time, the inclination of the fed sheet S is corrected and the conveyance timing is adjusted by the resist roller portion provided with the resist roller pair 53a. Then, in the image former 40, the toner image of the intermediate transfer belt 421 is secondarily transferred collectively onto one side of the sheet S, and the fixing process is performed in the fixer 60. The sheet S on which the image has been formed is discharged to the outside of the apparatus by the sheet discharger 52 including a discharge roller 52a.

The chart reader 80 is provided for reading a diagnostic test chart image (described later) formed (generated) on the sheet S. In a specific example, the chart reader 80 is an optical scanner device including a CCD sensor or the like described above.

In one or more embodiments, the chart reader 80 is disposed downstream of the fixer 60 and upstream of the sheet discharger 52. As another example, the chart reader 80 may be disposed in an image reading apparatus (not illustrated) connected downstream of the image forming apparatus 1 as a component of an image forming system.

The chart reader 80 operates based on a control signal from the controller 100, reads a test chart image formed on the sheet S, and outputs the read image data to the controller 100. The chart reader 80 corresponds to a “test image reader” of one or more embodiments of the present invention.

(Image Inspection Process)

The image forming apparatus 1 configured as described above sometimes fails to form a correct image on the sheet S due to the durability of its components, resulting in image defects such as streaks and density unevenness.

Therefore, in the image forming apparatus 1, a test chart for image analysis is printed on the sheet S, the test chart on the sheet S is read by the chart reader 80, and the occurrence of an image defect or the like is inspected by the controller 100. Further, in the image forming apparatus 1, when the occurrence of an image defect is detected as the result of the inspection, processing for identifying the part to be subjected to maintenance (replacement or the like) is performed based on the detection result.

However, according to the conventional image inspection method, deterioration occurs in the performance (accuracy) of detecting image defects in a case where multiple types of image defects occur in one place on the sheet S. For example, when two types of image defects: a streak and density unevenness, occur in a concentrative manner in the solid image of one color material on the test chart, streak detection performance becomes poor in the density-difference-based analysis of image defects in the prior art.

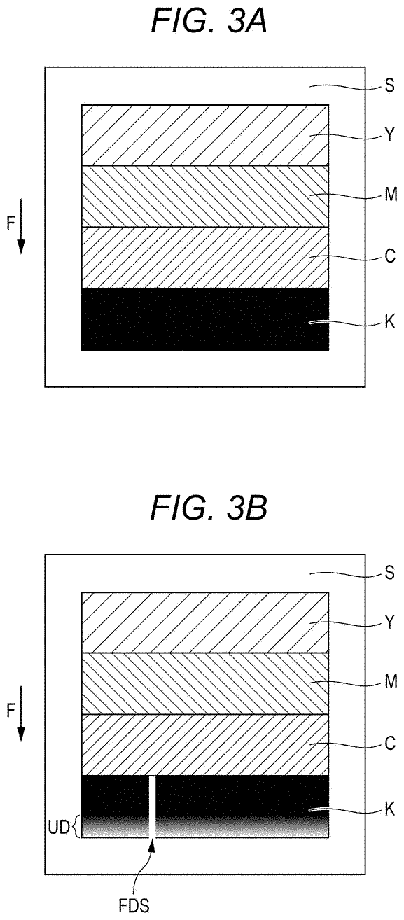

This further leads to a state, in the prior art, where the deterioration in image defect detection performance makes it impossible to identify the parts that have caused the defects. Hereinafter, the above-described matters in the prior art will be described with reference to FIGS. 3A and 3B.

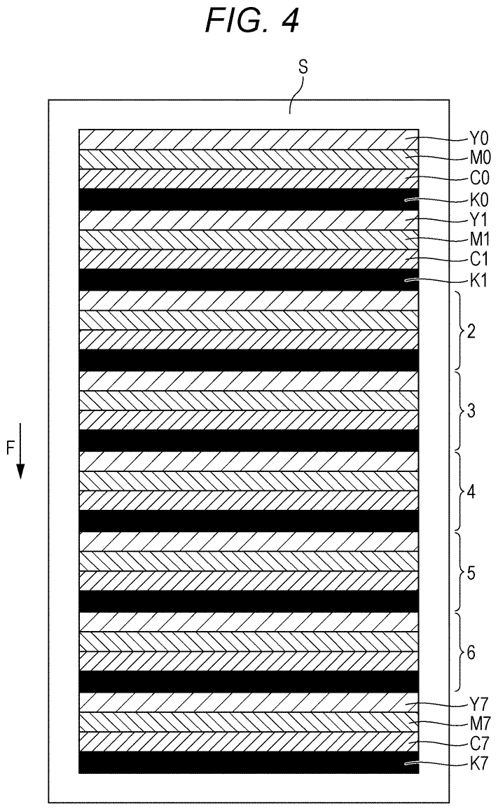

FIGS. 3A and 3B are plan diagrams illustrating an example of a test chart used (created) for conventional image inspection. FIG. 3A depicts a case where no image defect has occurred, and FIG. 3B depicts a case where image defects have occurred. An arrow F indicates the direction in which the sheet S is conveyed. The same applies to FIG. 4 and the subsequent drawings.

As illustrated in FIG. 3A, a test chart used for conventional image inspection is exemplified by rectangular solid images with different color materials (here, Y, M, C, and K toners) continuously formed in different regions on the sheet S. More specifically, in this example, rectangular solid images of Y, M, C, and K color toners are formed on the sheet S from the upstream side in the conveying direction such that the long sides thereof are in contact with each other.

Each of the rectangular solid images (Y, M, C, and K) illustrated in FIG. 3A corresponds to a “first image” of one or more embodiments of the present invention.

A comparison between FIG. 3A and FIG. 3B shows that, in the example illustrated in FIG. 3B, a streak FDS (hereinafter referred to as a FD streak) along the conveying direction and density unevenness UD have occurred as image defects in the solid image of K color printed on the leading side of the sheet S in the conveying direction.

As described above, when multiple types of image defects occur in a concentrative manner (in this case, partially overlap each other) in one place (one color material region) on the sheet S, streak FDS detection performance becomes poor in the density-difference-based analysis of image defects in the prior art.

In the example illustrated in FIG. 3B, it is not possible to clearly determine whether the cause of the image defects (in this example, FD streak and density unevenness) is a part of the color unit (in this example, black (K)) or a part such as the intermediate transfer belt 421 shared by all the colors.

In view of the various matters in the prior art described above, the inventors have found that the performance of identifying the part that has caused an image defect can be improved by performing the process of dividing an image of one color material (first image) into a plurality of second images and forming these pluralities of second images on an image carrier (in this example, the sheet S) in a distributed manner.

Further, the inventors have found that when multiple types of image defects occur, deterioration in image defect detection performance can be prevented by performing the process of reading the plurality of second images formed on the image carrier (sheet S) by the chart reader 80 and selecting and combining, from among the plurality of read second images, a smaller number of second images than the number of divisions of the first image.

Hereinafter, an image inspection method and the like executed by the image forming apparatus 1 according to one or more embodiments will be described in more detail.

In the image forming apparatus 1 according to one or more embodiments, for image inspection, the controller 100 controls the image former 40 and the like to create a test chart by distributing images of one color material in a plurality of regions of the sheet S.

That is, in one or more embodiments, under the control of the controller 100, the image former 40 creates a test chart by distributing images of two or more colors in a plurality of predetermined regions of the sheet S provided for each color material.

FIG. 4 is a diagram illustrating a specific example of a test chart for image inspection used in the image forming apparatus according to one or more embodiments. The test chart according to one or more embodiments illustrated in FIG. 4 is eight sets of band-shaped or long rectangular solid images of four colors Y, M, C, and K printed on a single sheet S, extending in the main scanning direction from the upstream side in the conveying direction.

Among these, each band-shaped image illustrated in FIG. 4 corresponds to a “second image” in one or more embodiments of the present invention. The example illustrated in FIG. 4 is an example of a test chart in which each of the Y, M, C, and K images (see FIG. 3A) corresponding to a first image is divided into eight second images, which are regularly arranged on the sheet S.

In the example illustrated in FIG. 4, under the control of the controller 100, the image former 40 forms, from the upstream side in the conveying direction of the sheet S, a yellow (Y) color toner image in the region Y0 illustrated in the drawing and a magenta (M) color toner image in the M0 region continuous with the toner image. Similarly, the image former 40 forms a cyan (C) color toner image in the C0 region and a black (K) color toner image in the K0 region.

Subsequently, the image former 40 forms a Y color toner image in the Y1 region continuous with the K0 region. Similarly, the image former 40 forms M, C, and K color toner images in the corresponding M1, C1, and K1 regions. The image former 40 repeats the above operation until it forms a K color toner image in the last K7 region to create the test chart illustrated in FIG. 4.

By using such a test chart, factors of image defects can be distributed by color, which makes it possible to clearly discriminate, for example, between streaks, density unevenness, and the like that occur in specific colors and streaks, density unevenness, and the like that occur due to failure in parts such as the intermediate transfer belt 421 used in common by all the colors.

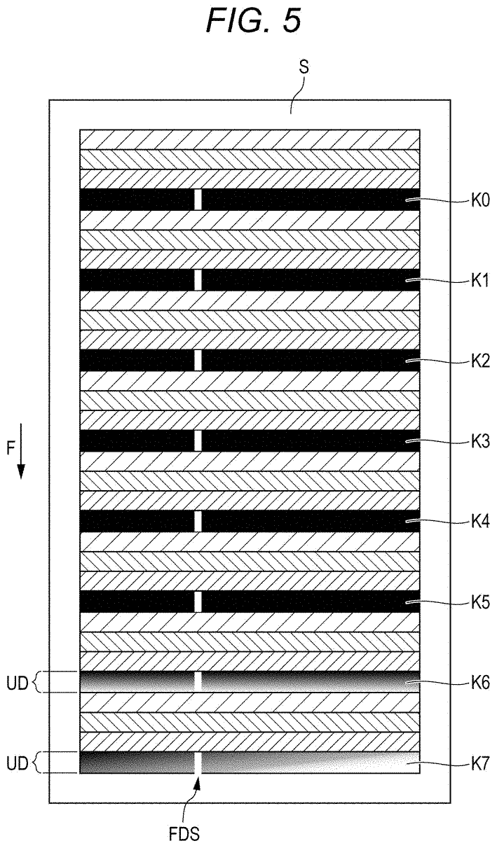

Hereinafter, with reference to FIG. 5 that depicts a case in which image defects occur when the test chart illustrated in FIG. 4 is printed on the sheet S, a method for determining the cause of the image defects will be described.

In the example illustrated in FIG. 5, FD streaks (FDS) occur only in the black (K) images in what is called an “intermittent” manner, and no FD streaks occur in any of the adjacent cyan (C), yellow (Y), and magenta (M) images. From this result, it can be estimated that the cause (factor) of the FD streaks (FDS) in the example of FIG. 5 is very likely to be a part of the black (K) image forming unit (hereinafter also referred to as the “K unit”).

In other words, the cause of the FD streaks (FDS) illustrated in FIG. 5 is unlikely to be a part used for images of all the Y, M, C, and K colors (hereinafter referred to a “common part”), such as the intermediate transfer belt 421 and the fixer 60.

If streaks occur continuously (not illustrated) over the region from K7 to Y7 (see FIG. 4), it can be estimated that these streaks are very likely due to a common part.

Further, as illustrated in FIG. 3B, when density unevenness UD occurs in the quarter area of the K image on one end side (lower side in FIG. 3B) along the sub-scanning direction of the test chart, dividing and distributing the solid image of each color as illustrated in FIG. 4 is effective in easily identifying the factor of the density unevenness UD.

That is, in the example illustrated in FIG. 5, the density unevenness UD occurs in the black images of the regions K7 and K6, and the density unevenness UD does not occur in the other color images such as the regions C7, M7, and Y7. Here, if the cause is a common part, the density unevenness UD should also occur in images such as the regions C7, M7, and Y7, which is not the case. Therefore, in the example of FIG. 5, the processor can determine that the part that has caused (contributed to) the density unevenness UD is very likely to be a part of the K unit.

In this manner, the configuration of a test chart according to one or more embodiments makes it easier to identify the part that has caused an image defect.

Further, in one or more embodiments, the chart reader 80 reads a test chart having the above-described configuration, and the controller 100 performs the process of selecting and combining, from among the plurality of read second images (e.g. the band-shaped images of K0 to K7), a smaller number of second images than the number of divisions of the first image.

In the examples illustrated in FIGS. 4 and 5, the controller 100 functions as the image combiner to perform the process of selecting a smaller number of second images than eight (i.e. the number of divisions) from among the band-shaped images of K0 to K7 (i.e. eight second images) read by the chart reader 80, and combining the selected images.

Furthermore, the controller 100 functions as the detector to perform the process of detecting an image defect from each combined image.

According to one or more embodiments that performs the above-mentioned processes, for example, an image is divided by image defect occurrence place (the number of divisions for second images is determined), or second images are combined by image defect occurrence place, so that deterioration in image defect detection performance can be prevented when multiple types of image defects occur.

Here, the number of divisions, that is, how many second images a first image is divided into, and how to combine second images can be appropriately determined by the controller 100 with reference to data on past image defect detection results and identified defective parts (hereinafter referred to as diagnostic data). Alternatively, past diagnostic data may be displayed on the display interface 21, so that the user can perform determination (setting) by operating the operation display interface 20. The above diagnostic data can be stored in any storage medium. The following description is based on the premise that the diagnostic data are stored in the storage 72.

The test chart illustrated in FIG. 4 has a relatively large number of divisions of a first image, leading to a new state where in a case where a part of a specific color unit is abnormal, it is difficult to determine or identify the resultant image defect.

Specifically, although FIGS. 4 and 5 are exaggerated for simplicity and easy understanding, actual FD streaks (FDS) can be fine lines or can be uneven in streak thickness. In such a case, if the images in the regions K1 to K7 are separately inspected, it may be difficult to detect some of the FD streaks (FDS). For example, in the example illustrated in FIG. 5, the FD streak FDS generated in the black image in the region K7 might be erroneously detected as a different image defect such as density unevenness.

Further, as illustrated in FIG. 5, when density unevenness UD occurs in a large part of a specific image (in this example, the black images in the regions K7 and K6) and another image defect (in this example, FD streaks FDS) also occurs, if the images in the regions K1 to K7 are separately inspected, it is difficult to determine the degree of the density unevenness UD in the regions K7 and K6.

It has been found that, in general, when image inspection is performed by a processor using a test chart having a plurality of distributions (divisions) for each color, the accuracy of identifying the part that has caused an image detect is improved, while the reference area (such as an image region that is referred to for comparison) is reduced, resulting in deterioration in the accuracy of determining the type and degree of the image defect.

Therefore, in a specific example of one or more embodiments, the controller 100 functions as the image combiner to perform the process of extracting images of one color material (second images) from a plurality of corresponding image regions of the test chart image read by the chart reader 80 and combining the plurality of extracted second images into a combined image of a size (area, shape, and the like) that enables analysis of an image defect.

In one or more embodiments, the controller 100 combines the long sides of the band-shaped images of the color of the image defect to analyze the image defect, that is, identify the type and degree of the image defect. In addition, the controller 100 identifies the part that has caused the image defect in consideration of the analysis result of the image defect and the position and color material of the images free from image defects.

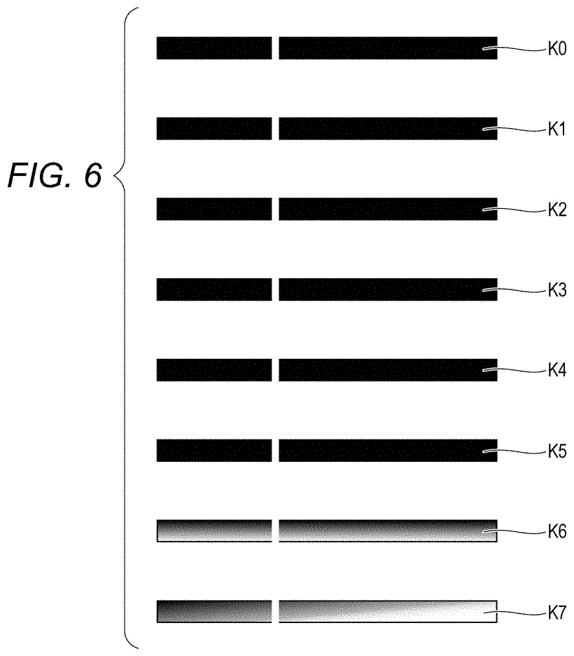

FIG. 6 is a diagram illustrating an example in which the controller 100 extracts the black images from a plurality of corresponding image regions (K0 to K7) of the test chart image (see FIG. 5) read by the chart reader 80.

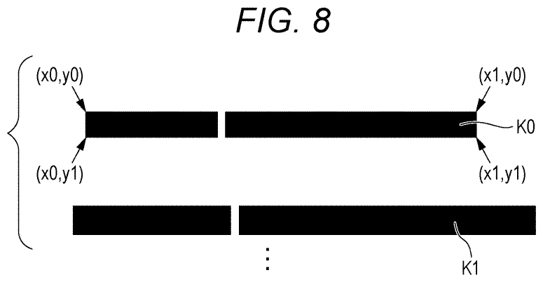

Here, regarding the extracted one-color images (see K0 to K7 in the drawing), the controller 100 applies a transformation matrix such as an affine transformation matrix (i.e. matrix process for incrementing the dimension by one) to the coordinate positions of the edges (in this example, the two-dimensional plane coordinates of the four corners, see FIG. 8) of the second images read by the chart reader 80, and translates specific images.

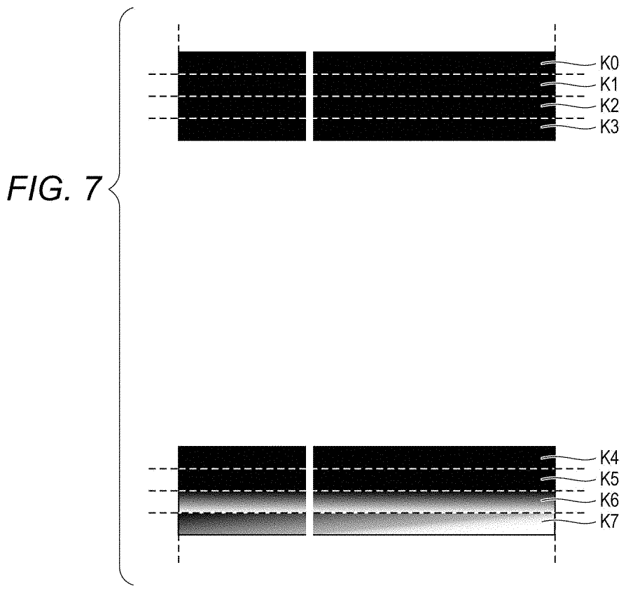

In this way, by performing image processing for translating specific images, the positions of the edges (four corners) of the images of each color material, and hence the positions of the image defects, can be substantially matched (see FIG. 7). A case where images are not completely aligned even after being translated will be described later.

Hereinafter, for convenience of explanation, the black images (second images) in the regions K0 to K7 are referred to as the “image K0”, “image K1”, and the like.

In the example illustrated in FIG. 7, the controller 100 performs the process of moving each of the images K1 to K3 to form a combined image of a size (area) that enables analysis of streaks by matching the upper end of the image K2 with the lower end of the image K1, matching the upper end of the image K3 with the lower end of the image K2, and matching the upper end of the image K4 with the lower end of the image K3.

By generating the upper combined image in this way, one of the two types of image defects (streaks and density unevenness) can be separated (only streaks can be extracted individually), so that deterioration in streak detection performance can be prevented.

Further, the controller 100 performs the process of moving each of the images K5 to K7 to form a combined image of a size (area) that enables analysis of density unevenness by matching the upper end of the image K5 with the lower end of the image K4, matching the upper end of the image K6 with the lower end of the image K5, and matching the upper end of the image K7 with the lower end of the image K6.

When the lower combined image is generated in this way, one of the two types of image defects cannot be separated (only density unevenness cannot be extracted individually). However, the controller 100 can estimate the streak position in the lower combined image by analyzing the upper combined image described above.

Therefore, the controller 100 ignores the image region including the streak position in the lower combined image during the analysis of the lower combined image (detection of an image defect), and performs the process of detecting an image defect in the other image regions, whereby the controller 100 can detect density unevenness in the lower combined image.

In this example, the controller 100 uses the two-dimensional coordinate positions of the lower ends of the images K4 and K0 as reference coordinate positions, and performs the process of moving and aligning the upper end or lower end of the other images (K5 to K7 and K1 to K3) with the reference coordinate positions. In this way, setting a plurality of second images as reference coordinate positions, that is, setting a plurality of second images that are not moved, is advantage for fast processing.

In some cases where, for example, K5 also has density unevenness UD, the combined image of K4 to K7 may not be sufficient for analyzing density unevenness UD. In such a case, the controller 100 only needs to use the two-dimensional coordinate positions of the lower end of the image K3 as reference coordinate positions, and perform the process of moving and aligning the upper end or lower end of the other images (K4 to K7) with the reference coordinate positions.

In another example in which only one type of image defect has occurred or there is density unevenness UD over a wide region in the second images (K1 to K7), for example, the controller 100 may use only the two-dimensional coordinate positions of the lower end of the image K0 as reference coordinate positions, and perform the process of moving and aligning the upper end or lower end of the other images (K1 to K7) with the reference coordinate positions (that is, the process of forming one combined image).

In one or more embodiments, the images of one color (for example, K0 to K7) constituting the test chart image are distributed on the sheet S. Therefore, the size and orientation of each image may not match due to bending or inclination of the sheet S that is read by the chart reader 80. FIG. 8 is an exaggerated diagram illustrating an example in which the portion of the image K1 printed on the sheet S bends and gets closer to the chart reader 80 during reading, as a result of which the image K1 is read as a larger image than the image K0.

In such a case, the controller 100 only needs to perform zoom (enlargement/reduction) or rotation processing on the second images (K0 to K7) as appropriate. In the example of FIG. 8, the controller 100 applies an affine transformation matrix to the coordinates of the two-dimensional plane positions of the four corners of the image K1 to translate the image K1, and performs the process of reducing the image K1 into the same size as the image K0.

By performing the above-mentioned processes, the controller 100 can combine the extracted second images of one color such that the edge positions of these second images are matched and the positions of the defects are also matched.

In the example illustrated in FIG. 5, if density unevenness UD occurs only in the image K7, it can be difficult for the processor to clearly determine whether the cause of the density unevenness UD is a part of the K unit or a common part.

Therefore, based on the analysis result of image defects by the controller 100 (acquired image defect periodicity information), the image former 40 creates a test chart under the control of the controller 100 such that an image of the same color as a past image defect is formed at a position shifted from the position of the past image defect on the sheet S.

In the case of the above example, the image former 40 creates a test chart by forming the image K7, for example, at the position of the image C7 (see FIG. 4) on the sheet S under the control of the controller 100, and accordingly shifting the other images such as C7 to adjacent positions one by one.

Thus, in the test chart, if density unevenness UD occurs again in the image K7, it can be determined that the cause of the density unevenness UD is likely to be a part of the K unit. In contrast, if density unevenness UD does not occur in any image, it can be determined that the cause of the density unevenness UD is likely to be a common part.

As described above, the process of shifting the entire test chart from a predetermined position on the sheet S may not be executed in a case where the sheet S does not have sufficient margin.

In such a case, based on the analysis result of image defects by the controller 100 (acquired image defect periodicity information), the image former 40 creates a test chart under the control of the controller 100 such that an image of the same color as a past image defect is formed at the position of an image of another color in a replacing manner.

In the case of the above example, the image former 40 creates a test chart by forming the image K7, for example, at the position of the image Y7 (see FIG. 4) on the sheet S under the control of the controller 100, and replacing the position of the image K7 with that of the image Y7 on the sheet S.

Thus, in the test chart, if density unevenness UD occurs again in the image K7, it can be determined that the cause of the density unevenness UD is likely to be a part of the K unit. In contrast, if density unevenness UD occurs in the image Y7, it can be determined that the cause of the density unevenness UD is likely to be a common part.

In one or more embodiments, in other cases where some image defect occurs and the part that has caused the image defect cannot be immediately identified, the entire test chart is shifted or an image of a specific color is replaced with an image of another color in the above-mentioned manner, whereby the part that has caused the image defect can be easily identified.

In addition, if the density unevenness UD has periodicity, by forming a K image at a position other than the position relating to the periodicity, the part that has caused the density unevenness UD can be easily identified. Specifically, if density unevenness UD appears again in the same location on the sheet S (that is, the leading end side in the conveying direction), it can be estimated that the cause is a common part. In contrast, if density unevenness UD appears in a different K-image location on the sheet S, it can be estimated that the cause is a part of the K unit.

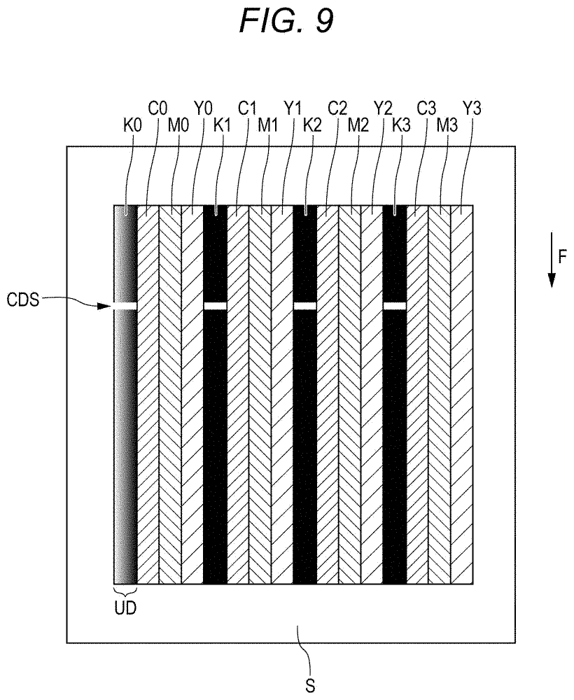

In the examples illustrated in FIG. 4 and the like, the band-shaped images of a plurality of colors (Y, M, C, and K) constituting the test chart extend in the main scanning direction. As another example, as illustrated in FIG. 9, the band-shaped images of a plurality of colors (Y, M, C, and K) constituting the test chart may extend in the sub-scanning direction (conveying direction).

In the example illustrated in FIG. 9, the number of distributions of each color (that is, the number of divisions for dividing a first image into second images) is set to four for the sake of simplicity, but the number of distributions (the number of divisions) is not limited and can be freely determined.

However, as illustrated in FIG. 9, in a case where the sheet S is conveyed in the longitudinal direction and the chart bands are also formed in the longitudinal direction, considering that the width is shorter than that of the chart bands formed in the lateral direction as described above with reference to FIG. 4, a relatively small number of distributions (number of divisions) may be set in the longitudinal direction in one or more embodiments.

In the example illustrated in FIG. 9, a streak CDS in the main scanning (CD) direction occurs in each of the four K solid images (K0 to K3), and density unevenness UD occurs in the left image K (K0) on the sheet S in FIG. 9.

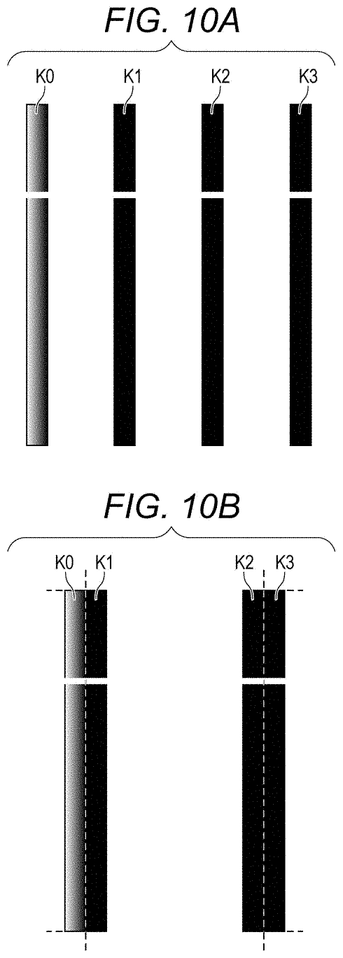

Even in such a case, image inspection can be performed using the processes mentioned above with reference to FIGS. 6 to 8. That is, the controller 100 extracts the second images read by the chart reader 80 by color (see FIG. 10A), selects a smaller number of second images than the number of divisions from among the extracted second images of one color (for example, the four images K0 to K3), and combines the selected second images such that the edge positions thereof are matched (see FIG. 10B).

Here, the controller 100 identifies the values of the two-dimensional coordinates of the edges (four corners) of the second images, performs coordinate translations using, for example, an affine transformation matrix, and applies a specific matrix to perform enlargement/reduction or rotation processing such that the edge positions and defect (in this example, CD streak) positions of the second images are aligned.

Thus, according to one or more embodiments, as illustrated on the right side of FIG. 10B, by generating the combined image (K2+K3) in which only streaks CDS of two types of image defects are extracted, deterioration in streak CDS detection performance can be prevented.

Further, for the combined image (K0+K1) illustrated on the left side of FIG. 10B, the controller 100 analyzes the combined image (K2+K3) in the above-mentioned manner to estimate the streak position in the combined image (K0+K1).

Therefore, the controller 100 ignores the image region including the streak position in the combined image (K0+K1) during the analysis of the combined image (K0+K1) (detection of an image defect), and performs the process of detecting an image defect in the other image regions, whereby the controller 100 can detect density unevenness in the combined image (K0+K1).

As described above, according to one or more embodiments, the cause of an image defect can be more easily identified, and even when multiple or multiple types of image defects occur in one color of the test chart formed on the sheet S, deterioration in detection performance or the like can be prevented.

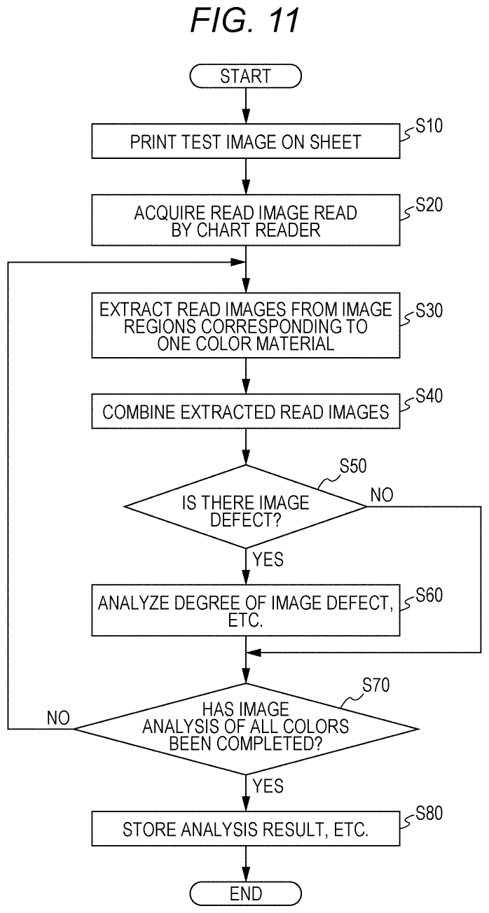

Hereinafter, a specific example of an image inspection method according to one or more embodiments will be described with reference to the flowchart illustrated in FIG. 11. This example assumes that the test chart described above with reference to FIG. 4 is printed on the sheet S and the image defects illustrated in FIG. 5 occur.

In step S10, the controller 100 determines the number of divisions (eight in this example) to divide a first image into second images, and controls the image former 40 and the like so as to form the test chart image illustrated in FIG. 4 on the sheet S. More specifically, the controller 100 reads the image data of a first image from the storage 72 or the like, controls the image forming units 41Y, 41M, 41C, and 41K so as to generate the determined number of divisional second images, and controls the sheet conveyer 50 so as to convey the sheet S.

Thereafter, under the control of the controller 100, the developing device 412 develops the test chart image on the surface of the photosensitive drum 413 as four color toner images (eight band images for each color). Then, the toner images of the test chart on the photosensitive drum 413 are sequentially superimposed and primarily transferred onto the intermediate transfer belt 421, and when the sheet S passes through the secondary transfer nip, the toner image on the intermediate transfer belt 421 is secondarily transferred onto the sheet S.

Subsequently, the sheet S on which the toner image (each of the second images) of the test chart has been formed is subjected to the fixing process by the fixer 60. Then, each of the second images of the test chart is read by the chart reader 80 disposed downstream of the fixer 60.

In step S20, the controller 100 acquires the data of each second image of the test chart read by the chart reader 80.

In step S30, the controller 100 extracts read images from the image regions corresponding to one color material (toner). In a specific example, the controller 100 refers to information on the color (K in this example) of the last image defect from the diagnostic data stored in the storage 72, and first extracts the two-dimensional coordinate positions of the four corners on the sheet S corresponding to the K color toner images (band shapes K0 to K7).

The two-dimensional coordinate positions can be represented as illustrated in FIG. 8: for example, the two-dimensional coordinate positions of the four corners of the image K0 can be represented by (x0, y0) for the upper left corner, (x1, y0) for the upper right corner, (x0, y1) for the lower left corner, and (x1, y1) for the lower right corner.

In step S40, the controller 100 performs the process of selecting and combining a smaller number of second images than the number of divisions (eight in this example) from among the extracted read images. In other words, as described above, the extracted one-color images (a plurality of band-shaped second images) are translated using an affine transformation matrix such that the edge positions of the images are matched, and zoom or rotation processing is executed as appropriate, whereby a plurality of combined images of a size (area) that enables image analysis are generated.

By the process of combining the second images, as illustrated in FIG. 7, a first combined image (K0+K1+K2+K3) and a second combined image (K4+K5+K6+K7) are generated.

In step S50, the controller 100 determines whether an image defect has occurred in each of the combined images.

Normally, it is necessary to determine the presence/absence of an image defect for each defect factor (type of image defect). Therefore, for example, the determination of the presence/absence of density unevenness UD and the determination of the presence/absence of an FD streak FDS cannot be performed in a single process. Therefore, the controller 100 refers as appropriate to past diagnostic data, estimates (predicts) the types of image defects that are likely to occur in the first combined image (K0+K1+K2+K3) on the upstream side in the conveying direction of the sheet S (see FIG. 5 and the like) and the second combined image (K4+K5+K6+K7) on the downstream side, and performs determinations for the predicted factors in order of prediction.

The above-described processes by the controller 100 make it possible to more quickly detect the FD streaks FDS in the first combined image and the second combined image and the density unevenness UD on the downstream part of the second combined image (K4+K5+K6+K7).

Thus, when the controller 100 determines that an image defect has occurred (step S50: YES), the controller 100 proceeds to step S60. On the other hand, when the controller 100 determines that no image defect has occurred (step S50: NO), the controller 100 skips step S60 and proceeds to step S70.

In step S60, the controller 100 performs a more detailed analysis of, for example, the degree (defect level) and periodicity of the image defect. In the above-mentioned manner, the controller 100 can refer as appropriate to diagnostic data relating to past image defects (the color of image defects, the type, degree, and periodicity of image defects, the position of image defects on the sheet S, identified parts, and the like) stored in the storage 72.

In step S70, the controller 100 determines whether the analysis of all the K, C, M, and Y colors (color materials) has been completed.

Here, when the controller 100 determines that the analysis of all the color images has not been completed (step S70: NO), the controller 100 returns to step S30 and repeats steps S30 to S70 described above.

On the other hand, when the controller 100 determines that the analysis of all the color materials has been completed (step S70: YES), the controller 100 proceeds to step S80.

In step S80, the controller 100 stores the current analysis result in the storage 72 and performs the following process.

If no image defect has been found in any color image of Y, M, C, and K, the controller 100 accordingly ends the process. At this time, the controller 100 may confirm the presence/absence of an image defect by referring to the data of the entire test chart image read by the chart reader 80.

On the other hand, if there is an image defect in one or more images of Y, M, C, and K (see YES in step S50 or the like), the controller 100 identifies the factor of the image defect (e.g. the part that has caused the defect) according to the color (only K in this example), type, degree, periodicity, etc. of the image defect.

Here, in order to identify the part or the like that has contributed to the image defect, the controller 100 can refer as appropriate to diagnostic data relating to past image defects (the color of image defects, the type, degree, and periodicity of image defects, the position of image defects on the sheet S, identified parts, and the like).

Further, if the degree of the image defect (FD streak FDS and density unevenness UD in this example) in the first or second combined image analyzed in step S60 exceeds a threshold value, the controller 100 performs control to notify the user that it is almost time to replace the identified part. This control includes displaying a notification message on the operation display interface 20, notifying a service person of a notification message via the communicator 71, or the like.

Thus, according to one or more embodiments in which the prediction and notification of the replacement time for a defective part are performed, the part in need of replacement can be replaced before the image forming apparatus 1 goes down due to a failure of the defective part, so that the downtime of the image forming apparatus 1 can be reduced.

The above-described embodiments have described examples in which a test chart is printed on the main surface (substantially the entire surface) of the sheet S. Alternatively, a test chart having the configuration described above with reference to FIGS. 3A, 3B, 9, or the like may be printed on a margin region of the sheet S. Such a modification is suitable for a case in which a post-processing apparatus (not illustrated) that cuts off the margin regions of the sheet S is connected to the downstream side of the image forming apparatus 1.

Forming a test chart of one or more embodiments in a margin region of the sheet S in this manner is advantageous in reducing the number of sheets S to be discarded and achieving resource saving.

However, in order to form a test chart having the configuration illustrated in FIGS. 3A, 3B, 9, or the like in a margin region of a single sheet S, it is necessary to reduce the size of the entire test chart for printing, which raises the possibility that an area sufficient for analyzing an image defect cannot be secured.

Therefore, when a test chart of one or more embodiments is formed in a margin region of the sheet S, the controller 100 may control the image former 40 such that the test chart is formed over a plurality of sheets S, in one or more embodiments. With such a configuration, printing in the margin of the sheet S can be performed with a lowered reduction rate for the entire test chart.

As described above in detail, according to one or more embodiments, when multiple types of image defects occur in a single test chart, deterioration in image defect detection performance can be prevented.

In addition, according to one or more embodiments, when an image failure occurs in one color of the test chart, the cause of the image defect can be more easily identified, and at the same time, deterioration in image defect detection performance can be prevented.

The above-described embodiments have described configuration examples in which the toner image of a test chart (a plurality of second images) is formed on the sheet S serving as an image carrier and the test chart on the sheet S is read by the chart reader 80. As another example, the chart reader 80 may be arranged to read a test chart (a plurality of second images) formed on another image carrier such as the intermediate transfer belt 421.

Although the embodiments of the present invention have been described and illustrated in detail, the disclosed embodiments are made for purposes of illustration and example only and not limitation. The scope of the present invention should be interpreted by terms of the appended claims. That is, the present invention can be implemented in various forms without departing from the gist or the main features thereof.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An image forming apparatus comprising:
an image former that divides a first image into a plurality of second images and forms the second images on an image carrier;
a test image reader that reads the second images formed on the image carrier; and
a hardware processor that:
selects a number of the second images from among the second images read by the test image reader, wherein the number of the second images is smaller than a number of division of the first image,
combines the selected second images into a combined image, and
detects an image defect in the combined image.

2. The image forming apparatus according to claim 1, wherein
the second images include images of one color material distributed in a plurality of predetermined regions of the image carrier, and
the hardware processor:
extracts the images of the one color material from the predetermined regions, and
combines the extracted images into the combined image that has a size that enables analysis of the image defect.

3. The image forming apparatus according to claim 2, wherein
the second images are band-shaped images distributed in the predetermined regions, and
the hardware processor combines long sides of the band-shaped images.

4. The image forming apparatus according to claim 2, wherein
the second images include images of two or more colors distributed in the predetermined regions provided for respective color materials.

5. The image forming apparatus according to claim 4, wherein
based on a detection result of the image defect by the hardware processor, the image former forms at least one of the second images of the color material same as color material of a past image defect at a position shifted from a region of the past image defect on a sheet.

6. The image forming apparatus according to claim 4, wherein
based on a detection result of the image defect by the hardware processor, the image former forms at least one of the second images of the color material same as color material of a past image defect in a region for a different color material.

7. The image forming apparatus according to claim 1, wherein
the image former forms the second images in a margin region of a sheet.

8. The image forming apparatus according to claim 7, wherein
the image former forms the second images over a plurality of the sheets.

9. The image forming apparatus according to claim 3, wherein
the image former forms the band-shaped images that extend in a main scanning direction or in a sub-scanning direction.

10. The image forming apparatus according to claim 3, wherein
the hardware processor combines, as the extracted images, band-shaped images of one color material such that edge positions of the band-shaped images are matched.

11. The image forming apparatus according to claim 10, wherein
the hardware processor combines, as the extracted images, the band-shaped images such that defect positions are matched.

12. The image forming apparatus according to claim 10, wherein
the hardware processor matches the edge positions of the extracted band-shaped images by applying an affine transformation matrix to a coordinate position of an edge of at least one of the second images read by the test image reader to move the one of the second images to a reference coordinate position.

13. The image forming apparatus according to claim 1, wherein
once a degree of the image defect exceeds a threshold value, the hardware processor outputs a notification indicating that it is time to replace a part of the image forming apparatus.

14. An image inspection method comprising:
dividing a first image into a plurality of second images and forming the second images on an image carrier;
reading the second images formed on the image carrier;
selecting a number of the second images from among the second images read by the test image reader, wherein the number of the second images is smaller than a number of division of the first image;
combining the selected second images into a combined image; and
detecting an image defect in the combined image.
